(19) United States
(12) Patent Application Publication
(10) Pub. No.: US 2020/0016732 A1
(43) Pub. Date: Jan. 16, 2020

(54) FLYWHEEL-DRIVEN SETTING DEVICE AND METHOD FOR OPERATING A SETTING DEVICE OF SAID TYPE

(71) Applicant: HILTI AKTIENGESELLSCHAFT, Schaan (LI)

(72) Inventors: Dominik SCHMIDT, Feldkirch (AT); Tilo DITTRICH, Feldkirch (AT); Raphael THON, Wiener Neustradt (AT)

(21) Appl. No.: 16/461,558

(22) PCT Filed: Nov. 14, 2017
(86) PCT No.: PCT/EP2017/079099

§ 371 Date: Jun. 7, 2019

(30) Foreign Application Priority Data
Nov. 18, 2016 (EP) 16199454.6

(51) Int. Cl. B25C 1/06; B25C 5/15

(52) U.S. Cl. CPC B25C 1/06; F41B 4/00; B25C 5/15

(57) ABSTRACT

A flywheel-driven setting device for driving fastening elements into a foundation is disclosed, having a driving element, which can be driven in a setting direction by a flywheel and which is guided between the flywheel, which is rotatable about a flywheel rotation axis, and a counter roller, which is rotatable about a counter roller rotation axis. The flywheel rotation axis is arranged at an angle alpha (α) to the counter roller rotation axis, wherein the angle is not equal to zero.

### TECHNICAL FIELD

The invention relates to a flywheel-driven setting device for driving fastening elements into a substrate, having a driving element, which can be driven in a setting direction by a flywheel and which is guided between the flywheel, which is rotatable about a flywheel rotation axis, and a counter roller, which is rotatable about a counter roller rotation axis. The invention also relates to a method for operating such a setting device.

### PRIOR ART

The German publication DE 10 2009 028 438 A1, the European publication EP 2 71 1 135 A2 and US patent No. 2011/0259937 A1 disclose setting devices in which a frictional connection is produced between the driving element and the flywheel during a setting process, in order to transmit rotational energy from the flywheel to the driving element.

### REPRESENTATION OF THE INVENTION

The object of the invention is to provide a flywheel-driven setting device for driving fastening elements into a substrate, having a driving element, which can be driven in a setting direction by a flywheel and which is guided between the flywheel, which is rotatable about a flywheel rotation axis, and a counter roller, which is rotatable about a counter roller rotation axis, which device is of simple design and is inexpensive to manufacture.

The object is achieved in a flywheel-driven setting device for driving fastening elements into a substrate, having a driving element, which can be driven in a setting direction by a flywheel and which is guided between the flywheel, which is rotatable about a flywheel rotation axis, and a counter roller, which is rotatable about a counter roller rotation axis, in that a surface normal of the preferably planar flywheel coupling surface is arranged at an angle alpha to the surface normal of the preferably planar counter roller coupling surface, which angle is not equal to zero.

The flywheel-driven setting device is preferably a hand-held setting device, which is also referred to as a setting tool. The driving element is, for example, a setting plunger, which can be moved back and forth in a translational way in the setting device in order to drive fastening elements into a substrate. The energy required for the movement of the driving element is advantageously transmitted from the flywheel, which is rotatable about the flywheel rotation axis, to the driving element. A return of the driving element after a successful setting process takes place, for example, in a manner known per se, by means of springs and/or rubber buffers. The angle alpha between the flywheel coupling surface and the counter roller coupling surface serves to form an oblique-wheel coupling, preferably with self-reinforcement or friction force amplification. The self-reinforcement or friction force amplification may advantageously reduce a pressing force, which brings the drive element into engagement with the flywheel. Due to the reduced contact force, the battery performance of the setting device can be improved. By inclining the flywheel coupling surface and the counter roller coupling surface, the contact area between flywheel/counter roller and the driving element can be effectively increased.

A preferred exemplary embodiment of the flywheel-driven setting device is characterized in that the flywheel rotation axis (5) is arranged parallel to the counter roller rotation axis (8). An alternative embodiment of the flywheel-driven setting device is characterized in that the flywheel rotation axis is also arranged at a non-zero angle alpha, preferably at the same angle as between the flywheel coupling surface and the counter roller coupling surface, to the counter roller rotation axis.

A preferred exemplary embodiment of the flywheel-driven setting device is characterized in that the driving element has a flywheel coupling surface, which is facing the flywheel, and which is arranged parallel to the flywheel rotation axis. The inclined flywheel coupling surface advantageously forms a wedge surface of the oblique-wheel coupling.

A further preferred exemplary embodiment of the flywheel-driven setting device is characterized in that the driving element has a counter roller coupling surface facing the counter roller, which is arranged parallel to the counter roller rotation axis. The inclined counter roller coupling surface advantageously forms a further wedge surface of the oblique-wheel coupling. The two coupling surfaces or wedge surfaces are preferably arranged symmetrically with respect to a central axis of the driving element.

Another preferred exemplary embodiment of the flywheel-driven setting device is characterized in that the driving element with the flywheel coupling surface and the counter rolling coupling surface has a wedge-shaped cross section. The wedge-shaped cross section of the driving element advantageously increases a normal coupling force of the oblique-wheel coupling. The wedge effect allows a high normal force and thus high frictional forces with a relatively low coupling force for closing the oblique-wheel coupling.

A further preferred embodiment of the flywheel-driven setting device is characterized in that the flywheel coupling surface and the counter roller coupling surface are designed as planar surfaces, which are in a friction-fit with side surfaces of the flywheel or the counter roller for driving the driving element. Due to the inclined coupling surfaces, in combination with the flywheel and the counter roller with a closed oblique-wheel coupling, a rolling movement with a low sliding component can be obtained. As a result, the wear during operation of the setting device can be reduced and its life can be increased. The wedge-shaped arrangement of the coupling surfaces allows almost any arbitrary enlargement of the friction contact surfaces between the flywheel/counter roller and driving element. This can be particularly advantageous in order to dispense with the provision of substantially V-shaped grooves on the driving element and the flywheel/counter roller. A flywheel of equal mass without grooves has a higher inertia than a flywheel with grooves. By omitting the grooves more energy can be advantageously stored in and retrieved from the flywheel at the same speed. This advantageously allows the production of setting devices with an increased setting energy.

Another preferred embodiment of the flywheel-driven setting device is characterized in that the angle alpha is an acute angle. The angle alpha is advantageously less than sixty degrees. It has been found in tests and experiments made in the context of the invention that a flywheel-driven setting device with an angle alpha between thirty and forty degrees provides the best results.

A further preferred exemplary embodiment of the flywheel-driven setting device is characterized in that an angle beta not equal to zero is provided between a perpendicular to a movement axis of the driving element and the flywheel rotation axis/counter roller rotation axis. The driving element is moved translationally along its movement axis when driving in a fastening element. The perpendicular to the axis of movement simultaneously represents an angle bisector of the angle alpha. Both the flywheel rotation axis and the counter roller rotation axis are arranged at an angle beta not equal to zero to the perpendicular. The angle beta is advantageously much smaller than the angle alpha. The angle beta is advantageously less than ten degrees. With the angle beta, self-reinforcement or friction force reinforcement of the closed oblique-wheel coupling is achieved in a particularly advantageous way. The angle beta is mainly responsible for the self-reinforcing engagement of the oblique-wheel coupling with the drive element, the flywheel and the counter roller as soon as the drive element comes into contact or engagement with the flywheel and the counter roller. The driving element is, so to speak, automatically drawn into the coupling system during a setting process, since a conveying action of the drive system pushes the driving element into the wedge-shaped tapering region between the flywheel and the counter roller. In particular, the coupling system is automatically wedged with the driving element between the flywheel and the counter roller.

A further preferred exemplary embodiment of the flywheel-driven setting device is characterized in that the line of action of a pressing force, which is applied for generating a coupling normal force onto the driving element, is perpendicular to one, or to the, movement axis of the driving element. When the contact force is applied to the driving element, the driving element is pressed with its coupling surfaces against the flywheel and the counter roller. In this case, rotational energy of the flywheel is frictionally transmitted to the driving element. The contact force is applied, for example, via a linear guide, onto the driving element. The application of the contact force can be performed, in a conventional manner, by means of a pinch roller, a wedge and a plunger, which is actuated by an electromagnet, for example.

Another preferred exemplary embodiment of the flywheel driven setting device is characterized in that the driving element is guided between two linear guides. For example, in cross section, the driving element has the shape of an isosceles trapezium with two parallel bases, which are connected to one another by two legs. The legs of the trapezoidal cross section of the driving element form the coupling surfaces. The two linear guides are preferably arranged on the base sides of the trapezoid of the wedge-shaped cross section of the driving element. Through the two linear guides the driving element is translationally guided back and forth.

In a method for operating a setting device described above, the above-mentioned object is alternatively or additionally achieved in that the driving element is driven in a self-reinforcing way upon closing of an oblique-wheel coupling formed with the flywheel and the counter roller. The driving element with the coupling surfaces is geometrically relatively simple and therefore inexpensive to produce. The same applies to the flywheel and the counter roller.

The invention optionally also relates to a driving element, a flywheel and/or a counter roller for a previously described setting device. The parts mentioned may be handled separately.

Further advantages, features and details of the invention will become apparent from the following description, in which, with reference to the drawings, various embodiments are described in detail. In particular:

FIG. 1 is a simplified perspective view of a flywheel drive of a setting device for driving fastening elements into a substrate;

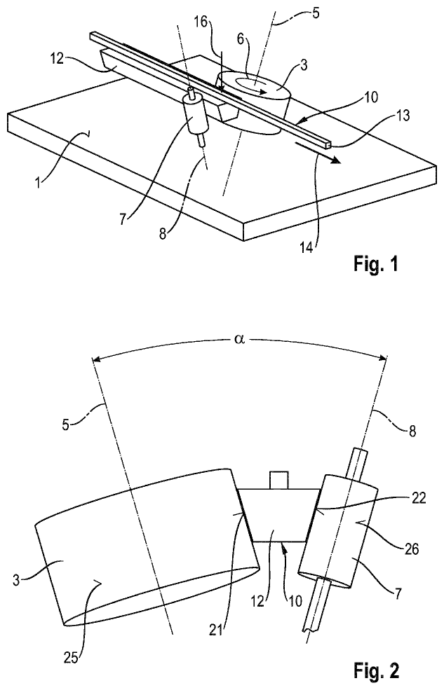

FIG. 2 is a rear view of the flywheel drive of FIG. 1;

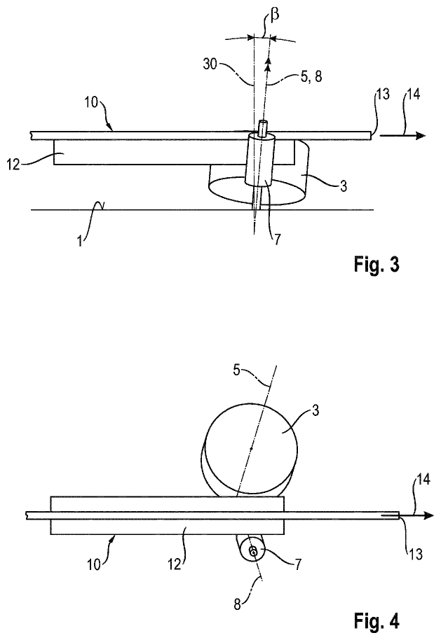

FIG. 3 is a side view of the flywheel drive of FIG. 1;

FIG. 4 is a plan view of the flywheel drive of FIG. 1;

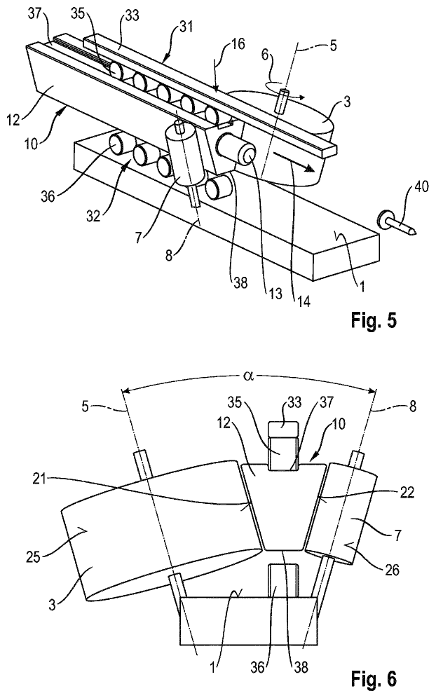

FIG. 5 is a perspective view of a similar flywheel drive as in FIG. 1, having linear guides for a driving element;

FIG. 6 is a rear view of the flywheel drive of FIG. 5;

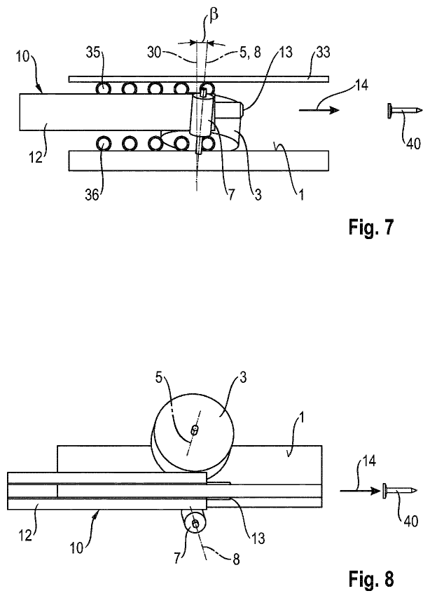

FIG. 7 is a side view of the flywheel drive of FIG. 5;

FIG. 8 is a plan view of the flywheel drive of FIG. 5;

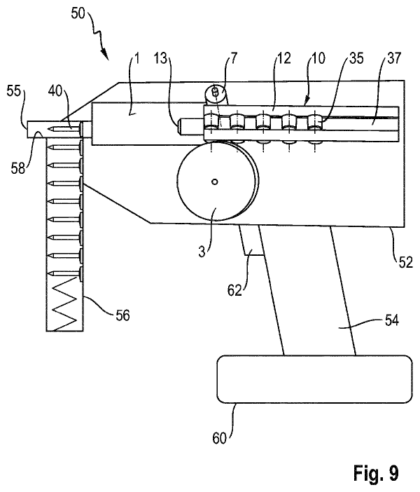

FIG. 9 is a simplified illustration of a setting device with a flywheel drive, as shown in FIGS. 5 to 8; and

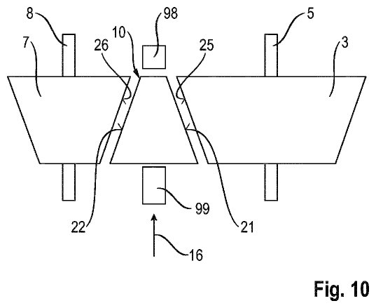

FIG. 10 is a rear view of a flywheel drive in a further embodiment.

### EXEMPLARY EMBODIMENTS

In FIGS. 1 to 8 and 10, three similar exemplary embodiments of a flywheel drive for a setting device or setting tool, as shown in FIG. 9, are shown in different views. To denote the same or similar parts, the same reference numerals are used for the sake of simplicity.

In FIG. 1, a reference surface 1, which is fixed to the housing, is shown by means of a substantially parallelepiped plate. A flywheel 3 is rotatable about a flywheel rotation axis 5 relative to the fixed reference surface 1, as indicated by an arrow 6. A counter roller 7 is also rotatable about a counter roller rotation axis 8 relative to the housing-fixed reference surface 1.

A driving element 10 is arranged between the flywheel 3 and the counter roller 7. The driving element 10 is designed as a setting plunger 12 having a plunger tip 13 and is translationally movable in the direction of an arrow 14 between the flywheel 3 and the counter roller 7. The arrow 14 illustrates a setting direction of a setting device provided with the flywheel drive.

The flywheel 3, the counter roller 7, and the driving element 10 represent an oblique-wheel coupling. When a pressing force indicated by an arrow 16 in FIG. 1 is applied from above onto the driving element 10, the driving element 10 or the setting plunger 12 is pressed with its flanks against the flywheel 3 and the counter roller 7. The rotational energy of the flywheel 3 indicated by the arrow 6 is then transmitted by friction to the driving element 10. As a result, the driving element 10 is translationally accelerated in the setting direction 14, so that a setting process can be performed.

In FIG. 2, the oblique-wheel coupling arrangement is shown with the driving element 10, the flywheel 3 and the counter roller 7 in a rear view. In the rear view it can be seen that the driving element 10 or the setting plunger 12 in cross section have the shape of a trapezoid with two parallel base sides, which are connected to each other by two legs.

The left leg in FIG. 2 of the wedge-shaped or trapezoidal cross section of the driving element 10 represents a flywheel coupling surface 21. The right trapezoidal leg in FIG. 2 is a counter roller coupling surface 22. The flywheel coupling surface 21 is frictionally connectable to a side surface 25 of the flywheel 3. Similarly, the counter roller coupling surface 22 is frictionally connectable with a side surface 26 of the counter roller 7.

In FIG. 2, it can be seen that the flywheel rotation axis 5 is arranged at an angle α to the counter roller rotation axis 8. The flywheel coupling surface 21 is arranged parallel to the flywheel rotation axis 5, whereby the flywheel 3 has a circular cylindrical shape. The counter roller rotation axis 8 is arranged parallel to the counter roller coupling surface 22, so that the counter roller 7 has a circular cylindrical shape.

It follows that the two coupling surfaces 21, 22 also include the angle α. The angle α between the flywheel rotation axis 5 and the counter roller rotation axis 8 is advantageously used for amplifying the frictional force. In a setting process, the driving element 10 or the setting plunger 12 in FIG. 2 moves into the plane of the drawing.

In FIG. 3, a line 30 indicates a perpendicular to a movement axis of the driving element 10. The movement axis corresponds to the setting direction 14 in FIG. 1. The arrow with two tips indicates that both the flywheel rotation axis 5 and the counter roller rotation axis 8 are arranged at an angle ß to the perpendicular 30.

The angle β describes the angle between the perpendicular 30 to the plunger axis of the setting plunger 12 and the rotation axis 5 or 8 of the flywheel 3 or counter roller 7. In analogy to the flywheel 3, the counter roller 7 can also be referred to as a counter wheel.

The angle ß is responsible for the fact that the oblique-wheel coupling has a self-reinforcing effect, as soon as the driving element 10 or the setting plunger 12 engages with the flywheel 3 and the counter roller 7. The setting plunger 12 and the driving element 10 are, so to speak, automatically drawn into the system during a setting process, since the conveying action of the drive system presses the setting plunger 12 or the driving element 10 downwards in FIG. 3.

In FIG. 4, the flywheel drive system of FIG. 1 is shown in plan view. In the plan view, it can be seen that the two axes of rotation 5, 8 are inclined twice by the angles α and β, so to speak.

FIGS. 5 to 8 show a similar flywheel drive system as in FIGS. 1 to 4. In FIGS. 5 to 8, two linear guides 31, 32 are additionally provided for the driving element 10. The linear guide 31 comprises a guide rail 33 and a guide track 37 on the driving element 10. In order to provide a low-friction guide, rollers 35 are arranged between the guide rail 33 and the guide track 37.

The linear guide 32 comprises rollers 36, which are arranged between the housing-fixed reference surface 1 and a guide track 38 on the driving element 10.

In FIG. 6, an enlarged representation of the guide clearance between the rollers 36 and the guide track 38 on the driving element 10 is shown.

In FIGS. 5, 7 and 8, a fastening element 40 is indicated for the purpose of illustrating a driving process with the driving element 10. The fastening element 40 is acted upon during the driving process by the plunger tip 13 of the setting plunger 12, which exerts a force in the setting direction 14.

In FIG. 9, a setting device 50 with a flywheel drive as shown in FIGS. 5 to 8 is shown in a simplified view. The setting device 50 comprises a housing 52 provided with the housing-fixed reference surface 1. The setting device 50 is designed as a hand-operated setting device having a handle 54 and a setting end 55.

The setting device or setting tool 50 is used for driving fastening elements 40 into a substrate (not shown). A desired number of fastening elements 40 is stored in a magazine 56 at the set end 55. The fastening elements 40 are individually removed from the magazine 56, preferably automatically, and provided in a bolt guide 58.

The energy required for driving the fastening elements 40 is provided, for example, in the form of electrical energy in an accumulator 60 at the lower end of the handle 54. The electrical energy stored in the accumulator 60 is converted into rotational energy by means of an electric motor, which is advantageously integrated in the flywheel 3.

The flywheel 3 is rotated by this rotational energy. Upon actuation of a trigger or operating knob 62 on the handle 54, the previously described oblique-wheel coupling is closed so that the rotational energy stored in the flywheel 3 is transferred as translational energy to the driving element 10 to initiate a setting operation.

FIG. 10 shows an oblique-wheel coupling arrangement according to a further exemplary embodiment in a rear view. The oblique-wheel coupling assembly comprises a driving element 10, a flywheel 3 with a flywheel rotation axis 5, and a counter roller 7 with a counter roller rotation axis 8. The cross section of the driving element 10 has the shape of a trapezoid with two parallel bases, which are interconnected by two legs. Furthermore, the oblique-wheel coupling arrangement comprises a guide rail 98.

The right leg of the wedge-shaped or trapezoidal cross section of the driving element 10 in FIG. 10 represents a flywheel coupling surface 21. The left trapezoidal leg in FIG. 2 represents a counter roller coupling surface 22. The flywheel coupling surface 21 is frictionally connectable to a side surface 25 of the flywheel 3. Similarly, the counter roller coupling surface 22 is frictionally connectable with a side surface 26 of the counter roller 7.

When a pressing force indicated by an arrow 16 in FIG. 10 is applied from below to the driving element 10 by means of a pressing element 99, the driving element 10 with the flywheel coupling surface 21 and the counter roller coupling surface 22 is pressed against the flywheel 3 and the counter roller 7. The rotational energy of the flywheel 3 is then transferred by friction to the driving element 10, in particular from the side surface 25 to the flywheel coupling surface 21. As a result, the driving element 10 is translationally accelerated in a setting direction, which is perpendicular to the plane of the drawing, so that a setting process can be performed.

In FIG. 10 it can be seen that the flywheel rotation axis 5 is arranged parallel to the counter roller rotation axis 8. The flywheel coupling surface 21 is disposed at an angle α to the flywheel rotation axis 5, whereby the flywheel has a truncated cone shape. The counter roller rotation axis 8 is likewise arranged at an angle α to the counter roller coupling surface 22, so that the counter roller 7 also has a truncated cone shape. The angle α between the flywheel coupling surface 21 and the counter roller coupling surface 22 is advantageously used for increasing the friction force.

1. A flywheel-driven setting device for driving fastening elements into a substrate, the setting device having a driving element, which can be driven in a setting direction by a flywheel and which is guided between the flywheel, which is rotatable about a flywheel rotation axis, and a counter roller, which is rotatable about a counter roller rotation axis; wherein the driving element comprises a flywheel coupling surface, which is connectable with the flywheel and a counter roller coupling surface, which is connectable with the counter roller, wherein a surface normal of the flywheel coupling surface is arranged at an angle alpha (α) to a surface normal of the counter roller coupling surface, and wherein the angle alpha (α) is not equal to zero.

2. The flywheel-driven setting device according to claim 1, wherein the flywheel rotation axis is arranged parallel to the counter roller rotation axis.

3. The flywheel-driven setting device according to claim 1, wherein the flywheel rotation axis is arranged at an angle alpha (α) to the counter roller rotation axis, and wherein the angle is not equal to zero.

4. The flywheel-driven setting device according to claim 3, wherein the driving element has a flywheel coupling surface, which is facing the flywheel, and which is arranged parallel to the flywheel rotation axis.

5. The flywheel-driven setting device according to claim 4, wherein the driving element has a counter roller coupling surface facing the counter roller, which is arranged parallel to the counter roller rotation axis.

6. The flywheel-driven setting device according to claim 5, wherein the driving element with the flywheel coupling surface and the counter roller rotation axis has a wedge-shaped cross section.

7. The flywheel-driven setting device according to claim 6, wherein the flywheel coupling surface and the counter roller rotation axis are formed as planar surfaces, which are in a friction-fit with side surfaces of the flywheel or the counter roller for driving the driving element.

8. The flywheel-driven setting device according to claim 1, wherein the angle alpha (α) is an acute angle.

9. The flywheel-driven setting device according to claim 1, wherein an angle beta (β) not equal to zero is provided between a perpendicular to a movement axis of the driving element and the flywheel rotation axis and the counter roller rotation axis.

10. The flywheel-driven setting device according to claim 1, wherein the line of action of a pressing force which is applied for generating a coupling normal force onto the driving element, is perpendicular to a movement axis of the driving element.

11. The flywheel-driven setting device according to claim 1, wherein the driving element is guided between two linear guides.

12. A method for operating a flywheel-driven setting device for setting fastening elements into a substrate, the setting device having a driving element, which can be driven in a setting direction by a flywheel and which is guided between the flywheel, which is rotatable about a flywheel rotation axis, and a counter roller, which is rotatable about a counter roller rotation axis; wherein the driving element comprises a flywheel coupling surface, which is connectable with the flywheel and a counter roller coupling surface, which is connectable with the counter roller, wherein a surface normal of the flywheel coupling surface is arranged at an angle alpha (α) to a surface normal of the counter roller coupling surface, and wherein the angle alpha (α) is not equal to zero, the method comprising driving in the driving element in a self-reinforcing way upon the closing of an oblique-wheel coupling formed with the flywheel and the counter roller.

13. The flywheel-driven setting device according to claim 2, wherein the angle alpha (α) is an acute angle.

14. The flywheel-driven setting device according to claim 3, wherein the angle alpha (α) is an acute angle.

15. The flywheel-driven setting device according to claim 4, wherein the angle alpha (α) is an acute angle.

16. The flywheel-driven setting device according to claim 5, wherein the angle alpha (α) is an acute angle.

17. The flywheel-driven setting device according to claim 6, wherein the angle alpha (α) is an acute angle.

18. The flywheel-driven setting device according to claim 7, wherein the angle alpha (α) is an acute angle.

19. The flywheel-driven setting device according to claim 2, wherein an angle beta (β) not equal to zero is provided between a perpendicular to a movement axis of the driving element and the flywheel rotation axis and the counter roller rotation axis.

20. The flywheel-driven setting device according to claim 3, wherein an angle beta (β) not equal to zero is provided between a perpendicular to a movement axis of the driving element and the flywheel rotation axis and the counter roller rotation axis.
